(19) United States
(12) Patent Application Publication
(10) Pub. No.: US 2006/0205631 A1
(43) Pub. Date: Sep. 14, 2006

(54) Structuring systems for fabric treatment compositions

(75) Inventors: Mark Allen Smerznak, Monkseaton (GB); Luc Marie Willy Lievens, Erpe Mere (BE)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/433,677

(22) Filed: May 12, 2006

Related U.S. Application Data
(63) Continuation of application No. 10/655,836, filed on Sep. 5, 2003, now abandoned.

(30) Foreign Application Priority Data
Sep. 5, 2002 (EP) 02447167.4
Aug. 29, 2003 (EP) 03447219.1

(51) Int. Cl. C11D 3/00

(52) U.S. Cl. 510/515

(57) ABSTRACT

The invention is directed to structuring systems suitable for incorporation into liquid fabric treatment compositions. Such structuring systems comprise, as added components, (A) a non-polymeric, crystalline, hydroxyl-containing structuring agent, which can crystallize to form a thread-like structuring network throughout liquid matrices; (B) a nonionic emulsifier; (C) an anionic emulsifier; and (D) a liquid carrier. The anionic emulsifier is present in such structuring systems, at concentrations from 0.1% to 8.0% by weight of the structuring system. The present invention also relates to processes for preparing such structuring systems and to the use of the structuring system of the present invention to control the particle size of a thread-like structuring material by mixing an anionic emulsifier with a structuring agent. Liquid fabric treatment compositions containing such structuring systems are also disclosed.

### CROSS REFERENCE TO RELATED APPLICATIONS

This application claims priority under 35 U.S.C. § 119(a) to European Application Serial No. 02447167.4, filed Sep. 5, 2002 (Attorney Docket No. CM2695F).

### FIELD OF THE INVENTION

This invention relates to structuring systems suitable for incorporation into liquid fabric treatment compositions. The invention also relates to processes for preparing such structuring systems. This invention further relates to liquid fabric treatment compositions comprising the structuring systems of the present invention.

### BACKGROUND OF THE INVENTION

When consumers launder fabrics, they desire not only excellence in cleaning, they also seek to impart superior fabric care benefits. Such fabric care effects can be exemplified by one or more of reduction of wrinkles benefits; removal of wrinkles benefits; prevention of wrinkles benefits; fabric softness benefits; fabric feel benefits; garment shape retention benefits; garment shape recovery benefits; elasticity benefits; ease of ironing benefits; perfume benefits; color care benefits; anti-abrasion benefits; anti-pilling benefits; or any combination thereof. Compositions which can provide fabric care benefits during laundering operations are known, for example in form of rinse-added fabric softening compositions. Compositions which can provide both cleaning and fabric care benefits, e.g., fabric softening benefits, at the same time, are also known, for example in the form of “2-in-1” compositions and/or “softening through the wash” compositions.

Fabric treatment compositions for use in laundering operations have been known for many years. They are available in solid form, e.g. in form of granules, in form of compressed tablets, and in liquid forms, e.g. as liquid compositions. Liquid fabric treatment compositions frequently comprise one or more a fabric care ingredients, which typically can be cationic compounds. More typically the cationic fabric care ingredient is a cationic silicone polymer comprising one or more polysiloxane units and one or more quaternary nitrogen units. WO 02/18 528 (P&G, published Mar. 7, 2002) describes fabric treatment compositions comprising a cationic silicone fabric care component and a nonionic surfactant.

Fabric care agents including cationic fabric care materials such as the silicone-based quaternary nitrogen materials just described are generally insoluble or of limited solubility in liquid fabric treatment compositions. Accordingly, they are generally found in such liquid products in the form of emulsions or dispersions. These liquid compositions will thus frequently contain, in addition to the fabric care agent, a structuring system comprising an emulsified structuring agent. Such a structuring system serves to stabilize the fabric care materials within the liquid fabric treatment compositions and to provide such liquid compositions with suitable Theological characteristics. The structuring agent also prevents the fabric care ingredient included in such compositions from separating, settling, coagulating and/or creaming.

The structuring systems for liquid fabric treatment compositions, typically in the form of emulsified, crystal-forming stabilizing agents, are frequently prepared as a premix and then added to the liquid products which contain the insoluble or limited soluble fabric care ingredients. In preparing such emulsified premixes of structuring agent, care is generally taken not to employ any emulsifiers which would be incompatible with the fabric care materials in the fabric treatment compositions with which the emulsified structuring system will be combined. Since, frequently such fabric care ingredients are cationic, there has been an incentive to avoid the use of anionic ingredients in preparing stabilizing systems so minimizing the possibility of deactivating any of the fabric care ingredients which are cationic. Accordingly, structuring systems known in the art have generally utilized a mixture of a structuring agent and nonionic emulsifiers, and/or amphoteric emulsifiers.

It has now been found that addition of small amounts of anionic emulsifiers to structuring systems suitable for incorporation into fabric treatment compositions can greatly enhance the ability of the structuring system to provide structured liquid fabric treatment compositions of especially desirable stability and rheology. Without being bound by theory, it is believed that the addition of anionic emulsifiers improves the crystallization of the structuring agent by controlling the structuring agent particle size during the crystallization process. This results in smaller, and more complex crystal structures to be formed. The effect of adding anionic emulsifiers to a structuring system is to provide a more efficacious structuring system with regards to structuring efficiency as it has been observed that less structuring agent is needed to achieve a specific rheology of a certain cationic fabric treatment composition. This in return, provides more flexibility for the formulator of such compositions to add additional ingredients providing additional benefits to the fabrics treated therewith. It has also been found that such beneficial anionic emulsifier can even be used for systems to be added to products containing cationic fabric care agents. This can be accomplished, for example, by adding a cationic scavenging agent for the anionic emulsifier to the structuring system or to the composition or both. In this manner, the benefits of using anionic emulsifier can be realized while avoiding the drawback which the use of anionics might otherwise impart to products containing cationic fabric care agents.

### SUMMARY OF THE INVENTION

The invention relates to structuring systems suitable for incorporation into liquid fabric treatment compositions. Such structuring systems comprise, as added components,

(A) a non-polymeric, crystalline, hydroxyl-containing structuring agent, which can crystallize to form a thread-like structuring network throughout liquid matrices;

(B) a nonionic emulsifier;

(C) an anionic emulsifier; and

(D) a liquid carrier.

The anionic emulsifier is present in such structuring systems, at concentrations from 0.1% to 8.0% by weight of the structuring system.

The present invention also relates to processes for preparing such structuring systems. Such processes comprise the steps of:

(A) premixing the anionic emulsifier with the liquid carrier;

(B) mixing the nonionic emulsifier with the premix from step (A); and

(C) mixing the structuring agent with the premix from step (B) to form the structuring system.

The invention further is directed to the use of an anionic emulsifier in such structuring systems of the present invention to control the particle size of a thread-like structuring agent.

Liquid fabric treatment compositions comprising the structuring systems of the present invention represent another embodiment of the present invention. Such liquid fabric treatment compositions have especially desirable stability and theological characteristics and impart superior fabric care benefits to fabrics treated therewith.

The invention also includes fabric treatment products in a wide range of forms and types. The objects, features and advantages of the invention are further borne out in the following detailed description, examples and appended claims.

### DETAILED DESCRIPTION OF THE INVENTION

Definition: The phrases “fabric care agent having limited solubility” or “limited soluble fabric care agent” as used herein means a fabric care agent having a solubility of less than 10 g, preferably of less than 5.0 g fabric care agent per 100 g of demineralized water.

A, Structuring Systems

The structuring systems of the present invention comprise four essential ingredients: a structuring agent, a nonionic emulsifier; an anionic emulsifier; and a liquid carrier.

Structuring agents—The present structuring systems comprise as an essential added component a structuring agent. The structuring agent is preferably present at concentrations from 0.1% to 80%, more preferably from 0.2% to 50%, even more preferably from 1.0% to 10%, and most preferably from 2.0% to 6.0% by weight of the structuring system.

The structuring agent is a non-polymeric, crystalline, hydroxyl-containing material which can crystallize to form a “thread-like” structuring network throughout liquid matrices. Generally, the structuring agent will comprise a fatty acid, a fatty ester, a fatty soap water-insoluble wax-like substance, and mixtures thereof. Suitably hydroxyl-containing materials are described in WO 00/26 285 and include hydroxyl-containing ethers. Other examples of suitable hydroxyl-containing materials include hydroxyalkylated polyhydric alcohol derivatives (WO 03/008527), aliphatic amide ethers (WO 03/040253), alkoxycarboxylate derivatives (WO 03/010 222), hydroxycarboxylic esters (DE 19 622 214) and amidated triglycerides (DE 19 827 304), provided that the selected material is hydroxyl-functional.

The crystalline, hydroxyl-containing structuring agent typically can be selected from the group consisting of: 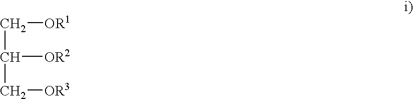
wherein R¹ is —C(O)R⁴, R² is R¹ or H, R³ is R¹ or H, and R⁴ is independently C₁₀-C₂₂ alkyl or alkenyl comprising at least one hydroxyl group; 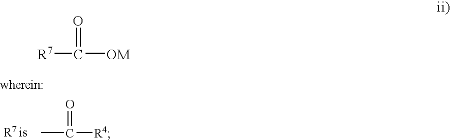
R⁴ is as defined above in i);
M is Na⁺, K⁺, Mg⁺⁺ or Al³⁺, or H; and iii) mixtures thereof.

Alternatively, the crystalline, hydroxyl-containing stabilizing agent may have the formula: 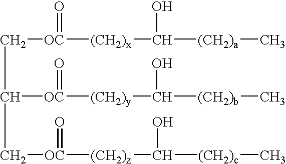
wherein:

(x+a) is from between 11 and 17; (y+b) is from between 11 and 17; and

(z+c) is from between 11 and 17. Preferably, wherein x=y=z=10 and/or wherein a=b=c=5.

Most preferably, the structuring agent is selected from castor oil, castor oil derivatives, especially hydrogenated castor oil derivatives, for example, castor wax, and mixtures thereof.

Highly preferred esters include triesters of 12-hydroxyoctadecanonic acid, though mono and diesters can also be present. It is preferred that the hydroxyl-containing material does not have ethoxylated or propoxylated components or moieties.

Commercially available crystalline, hydroxyl-containing stabilizing agents include THIXCIN® from Rheox, Inc., now Elementis.

Without intending to be limited by theory, the crystalline, hydroxyl-containing structuring agents are agents which form a thread-like structuring network when crystallized within a liquid matrix. This network reduces the tendency of materials within the liquid wherein the network forms, to coalesce and/or phase split. It is believed that the thread-like structuring system forms a fibrous or entangled threadlike network in-situ on cooling of the matrix. The thread-like structuring system can have an average aspect ratio of from 1.5:1, preferably from at least 10:1, to 200:1.

The thread-like structuring system can be made to have a viscosity of 2000 cstks or less at an intermediate shear range (5 s⁻¹ to 50 s⁻¹) which allows the processing of a system while the low shear viscosity of the product at 0.1 s⁻¹ can be at least 2000 cstks but more preferably greater than 20,000 cstks.

Emulsiflers—The structuring systems of the present invention must also comprise both a nonionic emulsifier and an anionic emulsifier. The total amount of emulsifier, defined as the sum of the concentrations of nonionic emulsifier and anionic emulsifier, will frequently be at least 5%, preferably at least 10%, more preferably at least 15% by weight of the structuring system and will preferably not exceed 50%, more preferably will not exceed 40%, and most preferably will not exceed 30% by weight of the structuring system. The anionic emulsifier preferably will be present at a concentration of from 0.1% to 8.0%, more preferably from 0.5% to 5.0%, even more preferably from 1.0% to 3.5%, and most preferably from 1.5% to 2.5% by weight of the structuring system.

The weight ratio of the nonionic emulsifier to the anionic emulsifier in the structuring system will generally range from 100:1 to 1:1, more preferably from 20:1 and 2:1 and most preferably from 15:1 and 4:1.

Nonionic emulsifiers: Generally, any conventional nonionic emulsifier can be used. Preferred are alkoxylated nonionic emulsifiers, especially ones containing only carbon, hydrogen and oxygen for inclusion in the present structuring systems. Amidofunctional and other heteroatom-functional types, however, can also be used. Ethoxylated, propoxylated, butoxylated or mixed alkoxylated, for example ethoxylated/propoxylated aliphatic or aromatic hydrocarbyl chain nonionic emulsifiers are more preferred. Suitable hydrocarbyl moieties can contain from 6 to 22 carbon atoms and can be linear, branched, cycloaliphatic or aromatic and the nonionic emulsifier can be derived from a primary or secondary alcohol.

Preferred alkoxylated emulsifiers can be selected from the classes of the nonionic condensates of ethoxylated and ethoxylated/propoxylated or propoxylated/ethoxylated linear or lightly branched monohydric aliphatic alcohols, which can be natural or synthetic. Alkylphenyl alkoxylates such as the nonylphenyl ethoxylates can also suitably be used.

Especially suitable as nonionic emulsifiers are the condensation products of primary aliphatic alcohols with from 1 to 75 moles of C₂-C₃ alkylene oxide, more suitably 1 to 15 moles, preferably 1 to 11 moles. Particularly preferred are the condensation products of alcohols having an alkyl group containing from 8 to 20 carbon atoms with from 2 to 9 moles and in particular 3 or 5 moles, of ethylene oxide per mole of alcohol.

Suitable nonionic emulsifiers containing nitrogen as a heteroatom include the polyhydroxy fatty amides having the structural formula R¹CONR²Z wherein R¹ is a C₅-C₃₁ hydrocarbyl, preferably straight-chain C₇-C₁₉ alkyl or alkenyl, more preferably straight-chain C₁₁-C₁₇ alkyl or alkenyl, or mixture thereof; R² is H, C₁-C₁₈, preferably C₁-C₄ hydrocarbyl, 2-hydroxethyl, 2-hydroxypropyl, ethoxy, propoxy, or a mixture thereof, preferably C₁-C₄ alkyl, more preferably methyl; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z preferably will be derived from a reducing sugar such as glucose, a corresponding preferred compound being a C₁₁-C₁₇ alkyl N-methyl glucamide.

Other nonionic emulsifiers useful herein include the so-called “capped” nonionics in which one or more -OH moieties are replaced by —OR wherein R is typically lower alkyl such as C₁-C₃ alkyl; the long-chain alkyl polysaccharides, more particularly the polyglycoside and/or oligosaccharide type, as well as nonionic emulsifiers derivable by esterifying fatty acids.

Other suitable nonionic emulsifiers belong to the group of semi-polar emulsifiers, known as amine-oxides, having the formula: R(EO)ₓ(PO)_{y}(BO)_{z}N(O)(CH₂R′)₂.qH₂O. R is a relatively long-chain hydrocarbyl moiety which can be saturated or unsaturated, linear or branched, and can contain from 8 to 20, preferably from 10 to 16 carbon atoms, and is more preferably C₁₂-C₁₆ primary alkyl. R′ is a short-chain moiety preferably selected from hydrogen, methyl and —CH₂OH, x, y, z are each from 0 to 100. When x+y+z is different from 0, EO is ethyleneoxy, PO is propyleneneoxy and BO is butyleneoxy. Amine oxide surfactants are illustrated by C₁₂₋₁₄ alkyldimethyl amine oxide.

Still another group of suitable nonionic emulsifiers is selected from the group of amine emulsifiers, preferably an amine emulsifier having the formula RX(CH₂)₂NR²R³ wherein R is C₆-C₁₂ alkyl; X is a bridging group which is selected from NH, CONH, COO, or O or X can be absent; x is from 2 to 4; R² and R³ are each independently selected from H, C₁-C₄ alkyl, or (CH₂—CH₂—O(R⁴)) wherein R⁴ is H or methyl. Particularly preferred emulsifiers of this type include those selected from the group consisting of decyl amine, dodecyl amine, C₈-C₁₂ bis(hydroxyethyl)amine, C₈-C₁₂ bis(hydroxypropyl)amine, C₈-C₁₂ amido propyl dimethyl amine, and mixtures thereof.

Anionic emulsifiers: Theoretically, By nature, every anionic emulsifier known in the art may be used in the structuring systems of the present invention. However, the structuring systems of the present invention comprise preferably at least a sulphonic acid emulsifier, such as a linear alkyl benzene sulphonic acid. However, water-soluble salt forms may also be used.

Anionic sulfonate or sulfonic acid emulsifiers suitable for use herein include the acid and salt forms of C₅-C₂₀, more preferably C₁₀-C₁₆, more preferably C₁₁-C₁₃ alkylbenzene sulfonates, C₅-C₂₀ alkyl ester sulfonates, C₆-C₂₂ primary or secondary alkane sulfonates, C₅-C₂₀ sulfonated polycarboxylic acids, and any mixtures thereof, but preferably C₁₁-C₁₃ alkylbenzene sulfonates.

Anionic sulphate salts or their acids suitable for use in the structuring systems of the invention include the primary and secondary alkyl sulphates, having a linear or branched alkyl or alkenyl moiety having from 9 to 22 carbon atoms or more preferably 12 to 18 carbon atoms.

Also useful are beta-branched alkyl sulphate emulsifiers or mixtures of commercial available materials, having a weight average (of the emulsifier or the mixture) branching degree of at least 50%.

Mid-chain branched alkyl sulphates or sulfonates are also suitable anionic emulsifiers for use in the structuring systems of the invention. Preferred are the C₅-C₂₂, preferably C₁₀-C₂₀ mid-chain branched alkyl primary sulphates. When mixtures are used, a suitable average total number of carbon atoms for the alkyl moieties is preferably within the range of from greater than 14.5 to about 17.5. Preferred mono-methyl-branched primary alkyl sulphates are selected from the group consisting of the 3-methyl to 13-methyl pentadecanol sulphates, the corresponding hexadecanol sulphates, and mixtures thereof. Dimethyl derivatives or other biodegradable alkyl sulphates having light branching can similarly be used.

Other suitable anionic emulsifiers for use herein include fatty methyl ester sulphonates and/or alkyl ethyoxy sulphates (AES) and/or alkyl polyalkoxylated carboxylates (AEC). Mixtures of anionic emulsifiers can be used, for example mixtures of alkylbenzenesulphonates and AES.

The emulsifiers are typically present in the form of their salts with alkanolamines or alkali metals such as sodium and potassium. Preferably, the anionic emulsifiers are neutralized with alkanolamines such as mono-ethanolamine or triethanolamine, and are fully soluble in the liquid phase of the structuring system.

Preferred anionic and nonionic emulsifies include those not having star, radial or multi block structures.

Liquid carriers—The structuring systems of the present invention further comprise as an added component a liquid carrier. A suitable liquid carrier can be selected from the group consisting of water, one or more organic solvents and mixtures thereof. Preferred organic solvents include monohydric alcohols, dihydric alcohols, polyhydric alcohols, glycerol, glycols, polyalkylene glycols such as polyethylene glycol, and mixtures thereof. Highly preferred organic solvents are mixtures of solvents, especially mixtures of lower aliphatic alcohols such as ethanol, propanol, butanol, isopropanol, and/or diols such as 1,2-propanediol or 1,3-propanediol; or mixtures thereof with glycerol. Suitable alcohols especially include C₁-C₄ alcohols. Preferred is 1,2-propanediol or ethanol and mixtures thereof. The liquid carrier is typically present at levels in the range of from 1.0% to 98%, preferably at least from 10% to 95%, more preferably from 25% to 75% by weight of the composition.

Optional Ingredients

pH-adjusting agents—Optionally, the structuring systems of the present invention may comprise one or more pH-adjusting agents. If present, the pH-adjusting agent is typically present at concentrations from 0.05% to 50%, preferably from 0.2% to 10%, more preferably from 0.3% to 5.0% by weight of the structuring system.

In general any known pH-adjusting agents are useful herein, including alkalinity sources as well as acidifying agents of either inorganic type and organic type.

Inorganic alkalinity sources include but are not limited to, water-soluble alkali metal hydroxides, oxides, carbonates, bicarbonates, borates, silicates, metasilicates, and mixtures thereof; water-soluble alkali earth metal hydroxides, oxides, carbonates, bicarbonates, borates, silicates, metasilicates, and mixtures thereof; water-soluble boron group metal hydroxides, oxides, carbonates, bicarbonates, borates, silicates, metasilicates, and mixtures thereof; and mixtures thereof. Preferred inorganic alkalinity sources are sodium hydroxide, and potassium hydroxide and mixtures thereof. Although not preferred for ecological reasons, water-soluble phosphate salts may be utilized as alkalinity sources, including pyrophosphates, orthophosphates, polyphosphates, phosphonates, and mixtures thereof.

Organic alkalinity sources include but are not limited to, primary, secondary, tertiary amines, and mixtures thereof.

Inorganic acidifying agents include but are not limited to, HF, HCl, HBr, Hl, boric acid, phosphoric acid, phosphonic acid, sulphuric acid, sulphonic acid, and mixtures thereof. Preferred inorganic acidifying agent is boric acid.

Organic acidifying agents include but are not limited to, substituted and substituted, branched, linear and/or cyclic C₁ to C₃₀ carboxyl acids, and mixtures thereof.

Suds suppressors—Optionally, the structuring systems of the present invention may comprise suds suppressors. If present, the suds suppressors are typically present at concentrations of less than 15%, preferably from 0.001% to 10%, more preferably from 0.01% to 8%, and most preferably from 0.05% to 5%, by weight of the structuring system.

Suitable suds suppressors for use herein may comprise essentially any known antifoam compound or mixture. Suitable suds suppressors can include low solubility components such as highly crystalline waxes and/or hydrogenated fatty acids, or more sophisticated compounded suds suppressor combinations, for example those commercially available from companies such as Dow Corning. More soluble antifoams include for example the lower 2-alkyl alkanols such as 2-methyl-butanol.

Excluded Ingredients

Structuring systems similar to those of the present invention are known in the art for the use in personal care products, such as deodorants and antiperspirants as disclosed for example in WO 00 / 44 339, in U.S. Pat. No. 5,972,320, and in GB 2 291 805.

The structuring systems herein, however, are to be used in fabric treatment products. Accordingly, the structuring systems of the present invention should be free of any antiperspirant actives, such as aluminum zirconium complexes, aluminum chlorohydrates, aluminum chlorohydroxides, and mixtures thereof as disclosed for example in WO 00 /44 339, in U.S Pat. No. 5,972,320, and in GB 2 291 805.

B, Processes for Preparing Structuring Systems

The structuring systems of the present invention can be prepared in any suitable manner and can, in general, involve any order of mixing or addition of the specified added components. However, it has been discovered that there exists a certain preferred way to accomplish such a preparation.

The first step involves the preparation of a premix comprising the anionic emulsifier and the liquid carrier. The second step involves the mixing of the nonionic emulsifier with the premix from the first step, preferably in the presence of a pH-adjusting agent. The structuring agent is then mixed with the resulting mixture from the second step to form the structuring system. Generally, the mixture so formed is heated up to a temperature above room temperature, preferably to above the melting point of the structuring agent. This heating can be applied either before adding the structuring agent, during the addition of the structuring agent, or even after the addition of the structuring agent to the mixture resulting from the second step. In cases where any mixture is heated to above room temperature, preferably to a temperature above the melting point of the structuring agent, it is preferred to thereafter cool down the resulting mixture to a temperature at or below the crystallization temperature of the structuring agent. The cooling process is preferably carried out with a cooling rate between 0.1° C./min to 200° C./min, more preferably with a cooling rate between 0.5° C./min to 20° C./min, even more preferably with a cooling rate between 1.0° C./min to 5.0° C./min and most preferably with a cooling rate between 1.5° C./min to 2.5° C./min. Generally, the cooling water temperature for this step is between 1° C. and 50° C., more preferably between 1° C. and 25° C., and most preferably between 1° C. and 10° C.

The structuring systems herein are described with respect to their components as added. Such components may, of course, react or otherwise change form once the structuring systems are prepared and all components have been combined.

The process for preparing the structuring systems of the present invention is preferably carried out by using conventional high-shear mixing means. This ensures proper dispersion of the ingredients throughout the final structuring system.

In a preferred embodiment of the present invention, the structuring system comprises as added components

(A) from 2.0% to 6.0% wt. of hydrogenated castor oil derivatives;

(B) from 10% to 40% wt. of a nonionic emulsifier;

(C) from 0.5% to 6.0% wt. of an anionic emulsifier; and

(D) from 48% to 87.5% wt. of a liquid carrier.

C. Liquid Fabric Treatment Compositions

The present invention is also directed to certain types of liquid fabric treatment compositions. Such liquid fabric treatment compositions comprise the structuring system of the present invention, preferably at a concentration from 0.1% to 50%, more preferably from 1.0% to 25%, even more preferably from 2.0% to 20% and most preferably from 4.0% to 15% by weight of the composition.

Such liquid fabric treatment compositions comprise further at least one fabric care agent having limited solubility within the liquid fabric treatment compositions herein. The structuring systems used in such liquid fabric treatment compositions serve to suspend such limited solubility materials within the liquid fabric treatment compositions and to thereby prevent visible settling or visible phase separation of such limited solubility materials within the liquid fabric treatment products of this invention.

A wide variety of such limited solubility fabric care agents may be used. These materials may be cationic, nonionic or anionic in nature. Examples of limited solubility fabric care agent types include fabric softening agents such as quaternary ammonium compounds and functionalized or non-functionalized silicones, anti-abrasion polymers, dye fixative agents, optical brighteners, fabric substantive perfumes, and soil release polymers. Such materials, for example, are described in detail in WO 02/40627. These limited solubility fabric care agents can generally be used in the liquid fabric treatment compositions herein in their conventional concentrations which can vary widely depending upon their function. Typical concentrations for such limited solubility fabric care agents can range, for example, from 0.1% to 50% by weight of the liquid fabric treatment compositions.

Especially preferred fabric care agents of limited solubility include the silicone-based fabric care agents such as those described in the Applicant's co-pending patent applications WO 02/18528 and EP 02 447 167.4. These are cationic, quaternary nitrogen-containing silicones which are especially effective fabric care agents. When such materials, or for that matter any of such limited solubility fabric care agents which are cationic in nature, are present, it may be desirable to also incorporate a cationic scavenging agent into the fabric treatment compositions herein. A cationic scavenging agent is a material which can interact with the anionic emulsifier that is brought into the compositions from the structuring system. Such a scavenging agent, for example dimethyl hydroxyethyl lauryl ammonium chloride, thus prevents this anionic emulsifier from deactivating the cationic fabric care agent. Types and functioning of suitable cationic scavenging agents are described in the Applicant's co-pending application EP 02 447 167.4.

The liquid fabric treatment compositions herein, containing a structuring system and one or more limited solubility fabric care agents such as described herein, will also generally contain a liquid carrier. Such a carrier, which is preferably water, can be of the same type described hereinbefore for use in the structuring systems. Liquid carrier will preferably comprise from 30% to 95% by weight of the liquid fabric treatment compositions herein, not including any such liquid carrier which is provided by the structuring system component of the compositions.

Further ingredients suitable for optional incorporation into the liquid fabric treatment compositions herein may include any conventional materials which are not necessarily fabric care agents and which are typically employed in products of this type, provided they are compatible with other composition components. These optional materials may be soluble or insoluble in such compositions. Examples include cleaning surfactants (anionic, nonionic, cationic, amphoteric, zwitterionic in nature, and mixtures thereof), coupling agents, perfumes, perfume precursors, chelating agents, bleaches, bleach activators, bleach catalysts, enzymes, enzyme stabilizing systems, dispersants or polymeric organic builders including water-soluble polyacrylates, acrylate/maleate copolymers and the like, dyes, colorants, filler salts such as sodium sulfate, hydrotropes such as toluenesulfonates, cumenesulfonates and naphthalenesulfonates, photoactivators, hydrolyzable surfactants, preservatives, anti-oxidants, germicides, fungicides, color speckles, colored beads, spheres or extrudates, sunscreens, fluorinated compounds, clays, pearlescent agents, luminescent agents or chemiluminescent agents, anti-corrosion and/or appliance protectant agents, processing aids, pigments, free radical scavengers, and pH control agents. Suitable materials include those described in U.S. Pat. Nos. 5,705,464; 5,710,115; 5,698,504; 5,695,679; 5,686,014; 5,646,101 and in WO 02/40 627 as well as in WO 02/18528.

Process for Preparing Fabric Treatment Compositions

Procedures suitable for preparing the fabric treatment compositions of the type contemplated by the present invention are disclosed in the Applicant's co-pending European patent application EP 02 447 167.4 and in WO 02/18528.

The liquid fabric treatment compositions of the present invention can in fact, be prepared in any suitable manner and can, in general, involve any order of mixing or addition of the specified added components. However, it has been discovered that there exists a certain preferred way to accomplish such a preparation.

The first step involves the preparation of a premix comprising the fabric care agent having limited solubility and the liquid carrier. Optionally, it may be desirable to add the cationic scavenging agent at this point to the premix. The second step involves the addition of the structuring system of the present invention. As noted herein before, this structuring system comprises the structuring agent, the nonionic emulsifier and the anionic emulsifier and a liquid carrier. The third step involves the preparation of yet a third mixture comprising all of the additional components of the fabric treatment composition, generally in the presence of a liquid carrier. It may be desirable to add to this third mixture the cationic scavenging agent. The last step involves the combination of all premixes and mixtures described above.

In the process for preparing the fabric treatment composition of the present invention, the cationic scavenging agent can be added either to the fabric care agent having limited solubility-premix or to the other component mixture or to both premixes.

This process for preparing the structured liquid fabric treatment composition of the present invention is also preferably carried out by use of conventional high-shear mixing means. This ensures proper dispersion of the ingredients throughout the final composition.

The fabric treatment compositions herein are described with respect to their components as added. Such components may, of course, react or otherwise change form once the compositions are prepared and all components have been combined.

Forms and Types of the Fabric Treatment Compositions

The structured liquid fabric treatment compositions of the present invention may be in any form, such as liquids (aqueous or non-aqueous), pastes, and gels. Encapsulated and/or unitized dose compositions are also included, as are compositions, which form two or more separate but combined dispensable portions. The liquid compositions can also be in a “concentrated” or diluted form. More preferred liquid fabric treatment compositions of the present invention include heavy duty liquid fabric treatment compositions and liquid laundry detergents for washing ‘standard’, non-fine fabrics as well as fine fabrics including silk, wool and the like. Compositions formed by mixing the provided compositions with water in widely ranging proportions are included. In case that the structured liquid fabric treatment composition of the present invention is in form of a non-aqueous liquid fabric treatment composition the composition suitably incorporated into a water-soluble film, e.g. a polyvinylalcohol-containing film, to form a unit dose laundry product.

The water content of the fabric treatment compositions of the present invention is intended to be either very low, such as from 0.1% to 10%, preferably from 0.5% to 5%, more preferably from 1.0% to 3.0% by weight of the composition, so that the resulting fabric treatment composition is suitable for incorporation into a water-soluble film, e.g. a polyvinylalcohol-containing film, to form a unit dose product or the water content of the fabric treatment compositins of the present invention is intended to be very high, such as at least 15%, preferably from 20% to 90%, more preferably from 25% to 50% by weight of the composition. Low water contents are being measured by Farl Fischer titration.

The pH of intended use of the liquid fabric treatment compositions of the present invention will generally range from pH 3 to pH 10, preferably from pH 6 to pH 8.5.

The structured liquid fabric treatment composition of the present invention may also be present in form of a rinse-added composition for delivering fabric care benefits, i.e., in form of a rinse-added fabric-softening composition, or in form of a rinse-added fabric finishing composition, or in form of a rinse-added wrinkle-reduction composition.

The liquid fabric treatment compositions of the present invention may be in the form of spray compositions, preferably contained within a suitable spray dispenser. The present invention also includes products in a wide range of types such as single-phase compositions, as well as dual-phase or even multi-phase compositions. The liquid fabric treatment compositions of the present invention may be incorporated and stored in a single-, dual-, or multi-compartment bottle.

### EXAMPLES

The following non-limiting examples are illustrative of the present invention. Percentages are by weight unless otherwise specified.

### Example (1)

Preparation of a Structuring Premix, Prepared According to the Process of the Present Invention.

1.55 g of C₁₃-C₁₅ alkylbenzene sulphonic acid are placed in 53.5 g of demineralized water under stirring. 0.42 g sodium hydroxide are added under stirring. 40 g of C₁₂-C₁₄ dimethyl amineoxide (32% active material in water) are added under stirring. The mixture is then heated up to 90° C. to 95° C.

4.5 g of hydrogenated castor oil are added. The mixture is then allowed to emulsify either by mixing for approximately one hour or by high shear mixing for approximately 15 minutes. The particle size distribution of the hydrogenated castor oil particle in the emulsion observed at this stage is typically between 10 μm and 15 μm (via Lasentec measurement).

The emulsion is then cooled down to a temperature of 65° C. via a heat exchanger with a cooling rate of 1.5° C./min. As of 65° C., the emulsion is then immediately cooled down (“flashed cooled down”) to a temperature below 35° C. via a heat exchanger. The resulting structuring system has a network of the crystallized hydrogenated castor oil suspended throughout.

### Example (2)

Preparation of a Structuring Premix, Prepared According to the Process of the Present Invention.

1.5 g of C₁₃-C₁₅ alkylbenzene sulphonic acid are placed in 54.1 g of demineralized water under stirring. 0.4 g sodium hydroxide are added under stirring. 40 g of Neodol 45-7 (1) are added under stirring. 4.0 g of hydrogenated castor oil are added while heating up the mixture to 90° C. to 95° C.

The mixture is then allowed to emulsify either by mixing for approximately one hour or by high shear mixing for approximately 15 minutes. The particle size distribution of the hydrogenated castor oil particle in the emulsion observed at this stage is typically between 10 μm and 15 μm (via Lasentec measurement).

The emulsion is then cooled down to a temperature of 70° C. via a heat exchanger with a cooling rate of 2.0° C./min. As of 70° C., the emulsion is then immediately cooled down (“flashed cooled down”) to a temperature below 35° C. via a heat exchanger. The resulting structuring system has a network of the crystallized hydrogenated castor oil suspended throughout.

The structuring systems of Examples 1 and 2 can be used to prevent fabric treatment compositions, containing limited soluble fabric care agents, from coagulating and/or creaming. Liquid fabric treatment compositions containing the structuring systems of examples 1 and 2 show excellent stability and rheology.

### Example (3)

Structured Heavy Liquid Detergent Composition

The final fabric treatment compositions are formulated by combining three distinctive premixes: 81 g of fabric cleaning premix A1, 14 g of structuring system premix B1, and 5 g fabric care premix C1 as set forth herein below. A second fabric treatment composition is obtained by combining 81 g of fabric cleaning premix A2, 14 g of structuring premix B2 and 5 g of fabric care premix C2.

Fabric cleaning premix (A):

| | Wt % in | Wt % in |
|---|---|---|
| | Formula A1 | Formula A2 |
| C₁₂-C₁₄ dimethyl amineoxide | — | 5.0 |
| (32% active material in water) | | |
| Neodol 45-7 (1) | 15.0 | 15.0 |
| Citric acid | 5.0 | 5.0 |
| Ethoxylated tetraethylene pentamine | 1.0 | 1.0 |
| Hydroxyethane dimethylene phosphonic | 0.4 | 0.3 |
| acid | | |
| Boric acid | 2.0 | 3.0 |
| CaCl₂ | 0.04 | 0.03 |
| Propanediol | 10.0 | 10.0 |
| Ethanol | 0.8 | 0.6 |
| Monoethanolamine | to pH 7.0-8.0 | to pH 7.0-8.0 |
| Protease enzyme (raw material) | 1.0 | 0.80 |
| Amylase enzyme (raw material) | 0.40 | 0.32 |
| Cellulase enzyme (raw material) | 0.02 | 0.01 |
| Mannanase enzyme (raw material) | 0.08 | 0.06 |
| Suds suppressor | 0.4 | 0.2 |
| Dye | 0.002 | 0.003 |
| Perfume | 0.4 | 0.8 |
| C₁₃-C₁₅ hydroxyethyl dimethyl | — | 1.5 |
| ammonium chloride | | |
| Water | Balance to 100 | Balance to 100 |

Structuring system premix (B):

| | Wt % in | Wt % in |
|---|---|---|
| | Formula B1 | Formula B2 |
| Hydrogenated castor oil | 4.5 | 6.0 |
| C₁₃-C₁₅ alkylbenzene sulphonic acid | 2.0 | 1.7 |
| Neodol 45-7 (1) | — | 30 |
| C₁₂-C₁₄ dimethyl amineoxide | 40 | — |
| (32% active material in water) | | |
| Boric acid | 0.37 | 0.51 |
| NaOH | 0.45 | 0.28 |
| Water | Balance to 100 | Balance to 100 |

Fabric Care premix (C):

| | Wt % in | Wt % in |
|---|---|---|
| | Formula C1 | Formula C2 |
| C₁₃-C₁₅ hydroxyethyl dimethyl | 1.0 | — |
| ammonium chloride | | |
| Cationic silicone solution (2) | 25.0 | 18.6 |
| C₁₂-C₁₄ dimethyl amineoxide | 10.0 | 3.2 |
| (32% active material in water) | | |
| Neodol 25-3 (3) | 6.0 | 6.0 |
| Ethanol | 6.5 | 4.7 |
| Water | Balance to 100 | Balance to 100 |

(1) Neodol 45-7: C₁₄, and C₁₅ alcohol ethoxylated with 7 eq. moles of ethylene oxide on average (Neodol ® 45-AE 7) ex Shell.
(2) Cationic silicone structure as disclosed in EP 02 447 167.4
(3) Neodol 25-3: C₁₂, and C₁₅ alcohol ethoxylated with 3 eq. moles of ethylene oxide on average (Neodol ® 25-AE 3) ex Shell.

The liquid fabric treatment compositions obtainable by combining premixes A1, B1 and C1 or by combining premixes A2, B2 and C2, respectively, demonstrate excellent product stability as fully formulated composition as well as in diluted form during a laundering cycle. These liquid fabric treatment compositions further provide excellent fabric cleaning and fabric care performance when added to the drum of an automatic washing machine wherein fabric are there and thereinafter laundered in conventional manner.

The liquid fabric treatment compositions as defined above are particularly advantageous with respect to fabric softening benefits imparted to fabrics treated therewith.

1-20. (canceled)

21. A structuring system suitable for incorporation into liquid fabric treatment compositions, which structuring system comprises as added components:
(A) from 1.0% to 10%, by weight of the structuring system, of a non-polymeric, crystalline, hydroxyl-containing structuring agent, which can crystallize to form a thread-like structuring network throughout liquid matrices;
(B) a nonionic emulsifier;
(C) from 1.0% to 3.5%, by weight of the structuring system, of an anionic emulsifier; and
(D) from 25% to 75%, by weight of the structuring system, of a liquid carrier; wherein the sum of the concentrations of anionic emulsifier and nonionic emulsifier is from 10% to 50%, by weight of the structuring system.

22. A structuring system according to claim 21 wherein the weight ratio of nonionic emulsifier to anionic emulsifier is between 100:1 to 1:1.

23. A structuring system according to claim 22 wherein in the structuring system, the weight ratio of the nonionic emulsifier to the anionic emulsifier is between 20:1 to 2:1.

24. A structuring system according to claim 21 wherein the structuring agent is present at a concentration from 2% to 6% by weight of the structuring system.

25. A structuring system according to claim 21 wherein the structuring agent is selected from the group consisting of fatty acids, fatty esters, fatty soap water-insoluble wax-like substances and mixtures thereof.

26. A structuring system according to claim 25, wherein the structuring agent is castor wax.

27. A structuring system according to claim 21 wherein the nonionic emulsifier is selected from the group consisting of alkoxylated nonionic emulsifiers, amidofunctional nonionic emulsifiers, condensation products of primary aliphatic alcohols with from 1 to 75 moles of C₂ to C₃ alkylene oxide, and from semi-polar emulsifiers having the formula:
R(EO)ₓ(PO)_{y}(BO)_{z}N(O)(CH₂R′)hd 2
wherein R is a saturated or unsaturated, linear or branched C₈ to C₂₀ hydrocarbyl moiety; R′ is a C₁ to C₄ hydrocarbyl moiety; and x, y, z are each from 0 to 100; and wherein the anionic emulsifier is selected from the group consisting of sulfonate or sulfonic acid emulsifiers including their acid form and their salt forms of C₅ to C₂₀ alkylbenzene sulfonates, C₅ to C₂₀ alkyl ester sulfonates, C₆ to C₂₂ primary or secondary alkane sulfonates, C₅ to C₂₀ sulfonated polycarboxylates acids, and mixtures thereof.

28. A structuring system according to claim 21 further comprising one or more components selected from the group consisting of pH-adjusting agents, suds suppressors, and mixtures thereof.

29. A structuring system according to claim 21 wherein the structuring system is free of any antiperspirant actives, such as aluminum zirconium complexes, aluminum chlorohydrates, aluminum chlorohydroxides, and mixtures thereof.
